(19) United States
(12) Patent Application Publication
(10) Pub. No.: US 2017/0158477 A1
(43) Pub. Date: Jun. 8, 2017

(54) Automatic Wine Bottle Opener

(71) Applicant: Byron Kahrs Varme, Houston, TX (US)

(72) Inventor: Byron Kahrs Varme, Houston, TX (US)

(21) Appl. No.: 14/937,854

(22) Filed: Nov. 10, 2015

(51) Int. Cl. B67B 7/04

(52) U.S. Cl. CPC B67B 7/0405

(57) ABSTRACT

A free standing wine bottle opener permits a wine bottle to be placed in a receptive opening in a base and having an upper housing for accommodating the corked end of the bottle. The upper housing includes a cork gripper attached to a motorized screw mechanism for engaging, twisting and lifting the cork relative to the bottle. The design is intended to provide a counter-top appliance (similar in size to a typical blender) in which the operator inserts the wine bottle into the base and then locks it in place and raises it to the winch mechanism. The winch mechanism is then activated to twist, lift and remove the cork. An electric motor is geared with the winch mechanism to rotate the winch when activated, making the system automatic. With the bottle resting on the base of the system and locked in place to prevent rotation, there is not any need for the operator to hold the neck of the bottle during the uncorking process.

### BACKGROUND

1. Field of the Invention

This invention is generally related to corkscrews for removing corks from wine bottles and the like and is specifically directed to a corkscrew assembly having a mechanized system for an auger type corkscrew.

2. Discussion of Prior Art

Corkscrews for removing the cork from a wine bottle and the like have been available for at least two centuries. S. Henshall patented an auger-type corkscrew in 1895 and the basic concept has not changed since that time. Numerous improvements have been made over the years.

Herbert Allen has received a patent for an improvement in the basic auger type screw and pull corkscrew as disclosed in U.S. Pat. No. 4,291,597 issued on Sep. 29, 1981. Mr. Allen has also received a patent on a lever-action corkscrew, U.S. Pat. No. 4,253,351 issued on Mar. 31, 1981.

Mr. Allen has also received numerous patents on variations of these designs, wherein the auger type screw is encapsulated in an outer sheath or cover which is adapted to fit over the mouth opening of the wine bottle, see U.S. Pat. No. 4,276,789 issued on Jul. 7, 1981; U.S. Pat. No. 4,377,096 issued on Mar. 22, 1983; U.S. Pat. No. 4,429,444 issued on Feb. 7, 1984; DES 293,414 issued on Dec. 29, 1987; U.S. Pat. No. 4,800,784 issued on Jan. 31, 1989; and U.S. Pat. No. 4,703,673 issued on Nov. 3, 1987.

In addition, Mr. Allen has two patents on a cork puller which does not rely on penetrating the cork but instead relies on twisting torque and a pulling action, see U.S. Pat. No. 4,800,783 issued on Jan. 31, 1989 and U.S. Pat. No. 5,042,331 issued on Aug. 27, 1991.

With the exception of the lever action design disclosed in U.S. Pat. No. 4,253,351 and the torque twist and pull designs shown in U.S. Pat. Nos. 4,800,783 and 5,042,331 all of the Allen corkscrews rely on an auger type tip for penetrating the cork and a twisting action wherein the twisting force is applied while gripping the corkscrew in a manner which is in axial alignment with the auger tip.

The inventor of the subject application was recently awarded U.S. Pat. No. 8,011,276. As shown in that patent, The invention not only provides a decorative corkscrew but also takes advantage of providing a rotary or twisting action outward of the auger axis, providing additional leverage for making it easier to twist the cork by applying a lower force. This is particularly advantageous when a person with small hands or limited strength is attempting to remove the cork from a bottle.

As shown in the patent, the corkscrew is housed in an attractive housing designed in appearance to resemble a nautical winch mounting block. The rotating actuator handle is in the shape of a winch handle. The corkscrew mechanism is in communication with the actuator handle and is housed in the mounting block housing. The winch handle may be oriented for turning about either a vertical or a horizontal axis.

The winch handle configuration provides additional torque when turning the corkscrew, facilitating the removal of the cork from a bottle. In addition, the winch handle design and decorative mounting block provide a decorative accent piece with the corkscrew being hidden from view when not in use.

The corkscrew assembly includes a body having an opening for communicating with the cork in the bottle. An auger tip is carried in the body and is adapted to be rotated and extended into and rotated and withdrawn out of contact with the cork. The drive mechanism is mounted in the body for rotating and extending and withdrawing the auger tip. A winch-type handle is mounted outside the body and in driving communication with the drive mechanism, whereby rotation of the winch handle activates the drive mechanism for rotating and extending and withdrawing the auger tip. The winch-type handle may be mounted either for rotation about a vertical axis or about a horizontal axis. When mounted for horizontal rotation a differential gear assembly is mounted in the body and in communication with both the drive mechanism and the winch-type handle for translating the horizontal rotation of the winch handle to a vertical rotation in communication with the drive mechanism.

### SUMMARY OF THE INVENTION

The subject invention is directed to an electrically operated winch-type corkscrew for a wine bottle cork and the like and is an improvement over my aforementioned U.S. Pat. No. 8,011,276. The “winch handle” has been replaced with a geared electric motor assembly for turning and lifting the cork out of a stationary wine bottle.

In its preferred embodiment the invention is free standing, permitting the wine bottle to be placed in a receptive opening and attached to the motorized screw mechanism. The design is intended to provide an attractive accent accessory that can be displayed when not in use.

Specifically, the wine bottle opener of the subject invention is a counter-top appliance (similar in size to a typical blender) in which the operator inserts the wine bottle into the base and then locks it in place and raises it to the winch mechanism. The winch mechanism is then activated to twist, lift and remove the cork.

An electric motor is geared with the winch mechanism to rotate the winch when activated, making the system automatic. With the bottle resting on the base of the system and locked in place to prevent rotation, there is not any need for the operator to hold the neck of the bottle during the uncorking process.

### BRIEF DESCRIPTION OF THE DRAWINGS

FIG. 1 is a perspective view of the automated wine winch of the subject invention.

FIG. 2 is a side view of the wine winch of FIG. 1.

FIG. 3 is a front view of the wine winch of FIG. 1.

FIG. 4 is a section view of the wine winch, taken along line A-A of FIG. 3.

FIG. 5 is an enlarged detail of a partial view of the crank and motor mechanism for twisting and lifting the cork out of the bottle, as indicated by the encircled area B on FIG. 4.

FIG. 6 is a section view of the wine winch, taken along line C-C of FIG. 2.

FIG. 7 is an enlarged detail of a partial view of the crank and motor mechanism for twisting and lifting the cork out of the bottle, as indicated by the encircled area D in FIG. 6.

### DETAILED DESCRIPTION

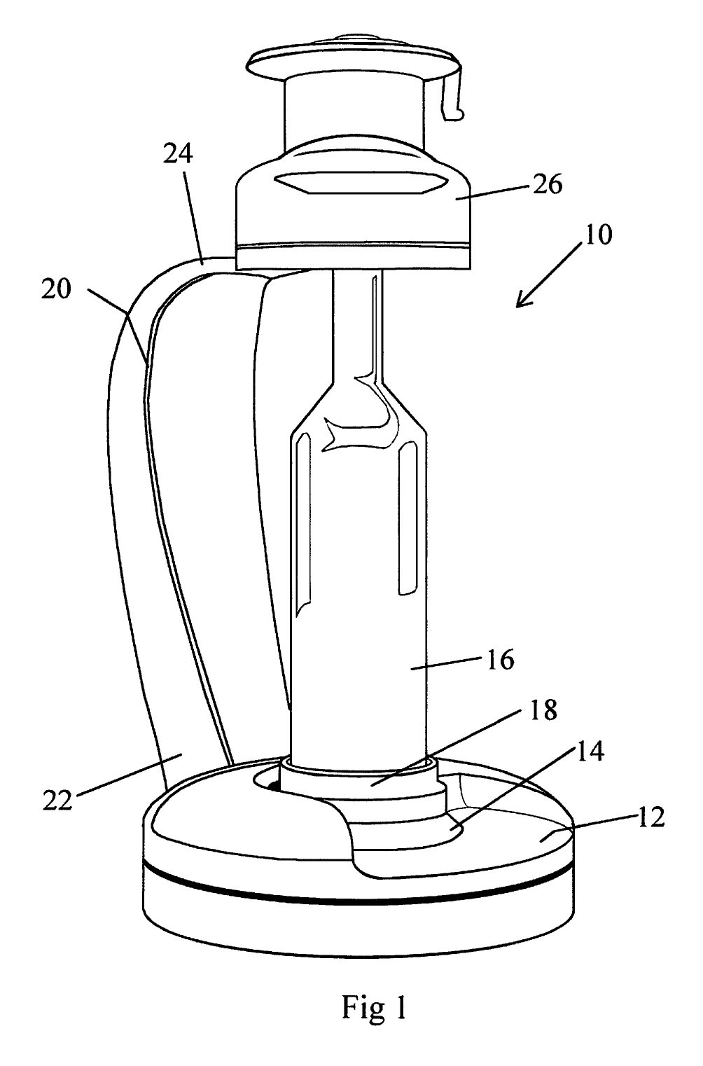

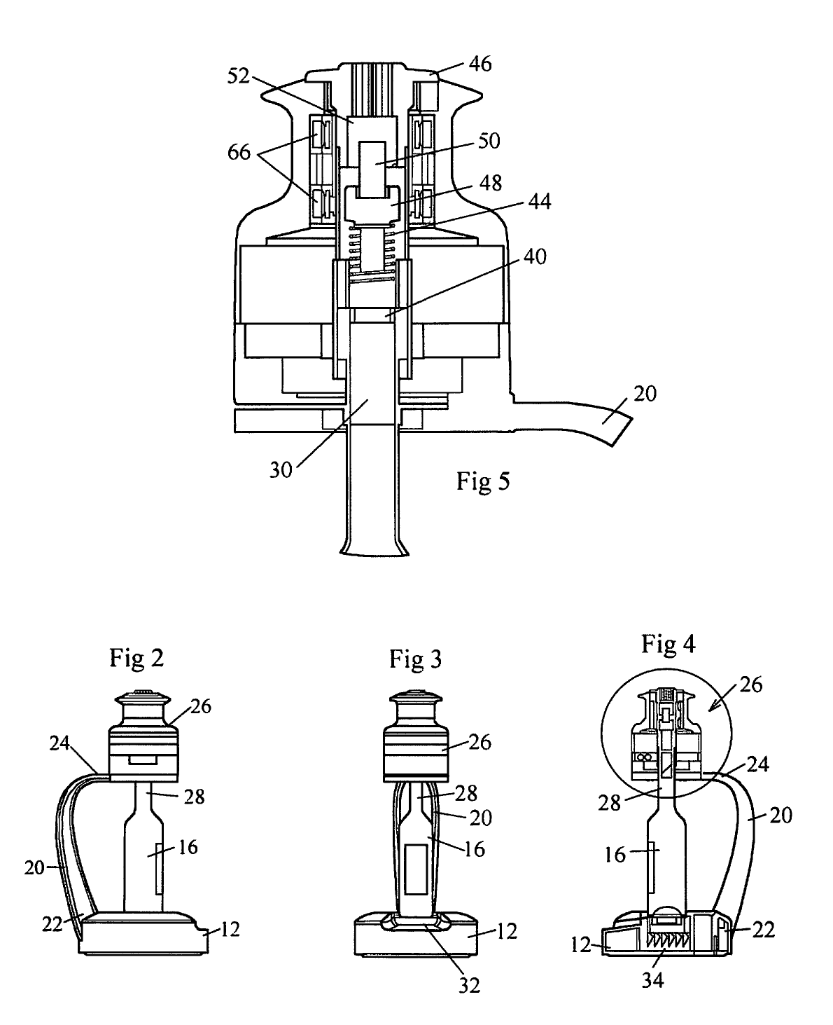

As shown in FIGS. 1, 2 and 3, the automated wine winch 10 of the subject invention includes a base 12 with a recess or socket 14 for supporting a typical wine bottle 16. In the preferred embodiment, the socket 14 includes a gripping collar 18 for securing the bottle in place and preventing it from rotating during operation. A support arm 20 has a lower end 22 attached to the base 12 and an upper end 24 attached to and supporting the winch mechanism 26.

Referring to FIGS. 4-7, it will be noted that the wine winch system is adapted for accommodating a wine bottle 16 having an elongated neck 28. The upper end of the neck is inserted into the winch mechanism 26. The system is designed to work with a wine bottle having a removable cork 30 in the upper end of the neck 28.

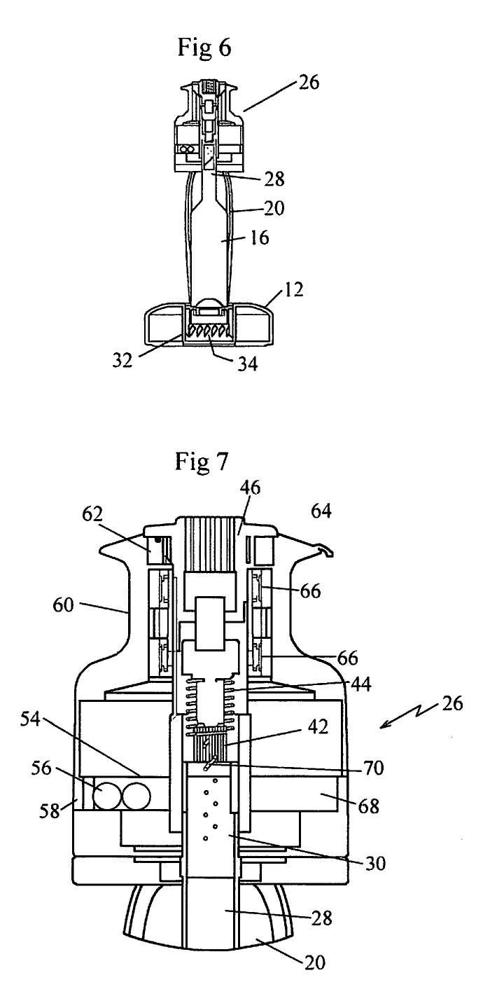

As shown in FIG. 3, the base 12 may be slotted at slot 32 to facilitate placement of the wine bottle into the system. As shown in FIGS. 4 and 6, the base may also include a gripping or locking mechanism 34 to prevent the wind bottle from turning when the winch is used to turn and lift the cork 30 out of the bottle.

FIGS. 5 and 7 are enlarged section views of the winch mechanism 26. As there shown, the interior of the upper corked end with cork 30 is inserted into the winch mechanism in a position permitting the cork gripper 40 to engage the cork 30. Anti-rotate tracks 42 are provided in the cork gripper to minimize or eliminate slippage between the cork gripper 40 and the cork 30. A compression spring 44 biases the cork gripper 40 toward and into contact with the cork 30. The cork gripper 40 is housed in a crank housing 46 which includes a gear box 48 for securing the cork gripper 40 in engaging relationship with the motor 50 through the gearbox assembly.

In the preferred embodiment the motor 50 is located in a motor housing 52 which in turn is located in the crank housing 46. A battery compartment 54 may be included for housing batteries 56 to provide power for the motor 50. In the alternative, the power may be supplied by typical house current or the like using a power cord and transformer (not shown). When a battery pack is used, an access door 58 may be provided.

In the illustrated embodiment, the winch mechanism comprises an outer housing or drum 62 with a central hollow core or channel 64 for housing the crank housing 46, motor assembly 50 and 52 and the cork gripper assembly 40 and spring 44. When the motor 50 is actuated, the cork gripper 40, which is in contact with the cork 30, rotates the corks and turns it out of the bottle.

It is desirable to provide centering bearings to assure smooth rotation between the outer drum 60 and the winch or crank mechanism 46. Control electronics may be housed in the outer drum, as indicated at 68. The screw mechanism 70 lifts and lowers the cork gripper when the cork gripper 40 is activated to rotate by the motor 50. The control electronics control the rotational direction of the cork gripper. The control electronics may also be used to engage and disengage a bottle lock mechanism 34 when employed, see FIGS. 4 and 6.

While certain feature and embodiments of the invention have been described in detail herein, it should be understood that the invention includes all modifications and enhancements within the scope and spirit of the following claims.

What is claimed is:

1. A wine bottle opener for removing a cork from a wine bottle, comprising:
a. A base adapted for holding a wine bottle;
b. An elongated arm substantially vertical support having opposite ends, with the base being secured to one support end;
c. A housing secured to the opposite endo the support, the housing adapted for receiving the corked end of the wine bottle;
d. A cork engaging gripper in the housing;
e. A motor for rotating and lifting the gripper when engaged with the cork for twisting and lifting the cork relative to the wine bottle.

2. The wine bottle opener of claim 1, wherein the housing includes an out component which is permanently secured to the support and an inner rotatable housing for carrying the cork gripper, wherein the inner housing rotates relative to the outer housing when the cork gripper is rotated by the motor.

3. The wine bottle opener of claim 2, further including a bearing assembly between the inner housing and the outer housing to assure smooth rotation between the housings.

4. The wine bottle opener of claim 1, wherein the base further includes a slot for accepting the wine bottle.

5. The wine bottle opener of claim 4, further including a locking mechanism in the slot for locking the wine bottle against rotation when the cork gripper is in contact with and lifting the cork.

6. The wine bottle opener of claim 5, wherein there is further included a control system for controlling the rotational direction of the cork gripper and wherein the control system further selectively engages and disengages the locking mechanism for locking the wine bottle against rotation.

7. A bottle opener for a bottle having a removable cap, the opener comprising:
a. A base for supporting the bottle;
b. A locking mechanism adapted for engaging the bottle when in the base to guard against rotation of the bottle;
c. An elongated support structure extending upwardly from the base substantially parallel to the longitudinal axis of the bottle;
d. A motorized opener mounted on the support structure;
e. A cap gripper in the motorized opener and adapted for engaging the removable cap;
f. A motor in the motorized opener for engaging and selectively activating the cap gripper for removing the cap from the bottle.
